(19) United States
(12) Patent Application Publication
(10) Pub. No.: US 2002/0187684 A1
(43) Pub. Date: Dec. 12, 2002

(54) Housing for a plug connector, in particular an antenna plug connector

(75) Inventor: Ludger Leve, Rahden (DE)

Correspondence Address: Norman P. Soloway, HAYES SOLOWAY, P.C., 130 W. Cushing Street, Tucson, AZ, 85701, US

(73) Assignee: HARTING Automotive GmbH & Co. KG

(21) Appl. No.: 10/163,321

(22) Filed: Jun. 5, 2002

(30) Foreign Application Priority Data
Jun. 6, 2001 (DE) 201 09 367.7

(51) Int. Cl. H01R 13/432

(52) U.S. Cl. 439/746

(57) ABSTRACT

A housing for a plug connector, in particular for an antenna plug connector, comprises a first housing part and a second housing part which each are made of a plastically deformed tube section and are inserted into each other.

### TECHNICAL FIELD

The invention relates to a housing for a plug connector, in particular for an antenna plug connector, which is arranged in a receptacle surrounding it and is locked in place there.

### BACKGROUND OF THE INVENTION

In order to be able to lock the antenna plug connector in the receptacle, the housing of the plug connector has to be provided on its outside with protrusions or similar formations, which can be engaged by locking elements or which can rest against a shoulder in the receptacle. Hitherto, such housings have been manufactured by turning on a lathe. This, however, is expensive.

It is the object of the invention to provide a housing, in particular a housing for an antenna plug connector, which can be produced more economically.

### BRIEF SUMMARY OF THE INVENTION

According to the invention there is provided a housing for a plug connector, in particular for an antenna plug connector, which housing comprises a first housing part and a second housing part which each are made of a plastically deformed tube section and are inserted into each other. In common terms, the invention is based on the basic idea to compose the housing of the plug connector of two suitable individual parts, so that the machining of a blank can be dispensed with. Instead of this, it is possible to use tube sections which can be obtained in the desired way by simple cutting off from a tube and suitable plastic deformation. These tube sections may then readily be inserted into each other, while with an appropriate dimensioning a press-fit between the two housing parts is sufficient to connect these firmly with each other.

Advantageous designs of the invention will be apparent from the sub-claims.

### BRIEF DESCRIPTION OF THE DRAWINGS

FIG. 1 shows in a schematic sectional view a plug connector having a housing according to a first embodiment;

FIG. 2 shows in a partial sectional view a variant of the housing of FIG. 1 in a suitable receptacle; and

FIG. 3 shows in a partial sectional view a housing according to a second embodiment.

### DETAILED DESCRIPTION OF THE PREFERRED EMBODIMENTS

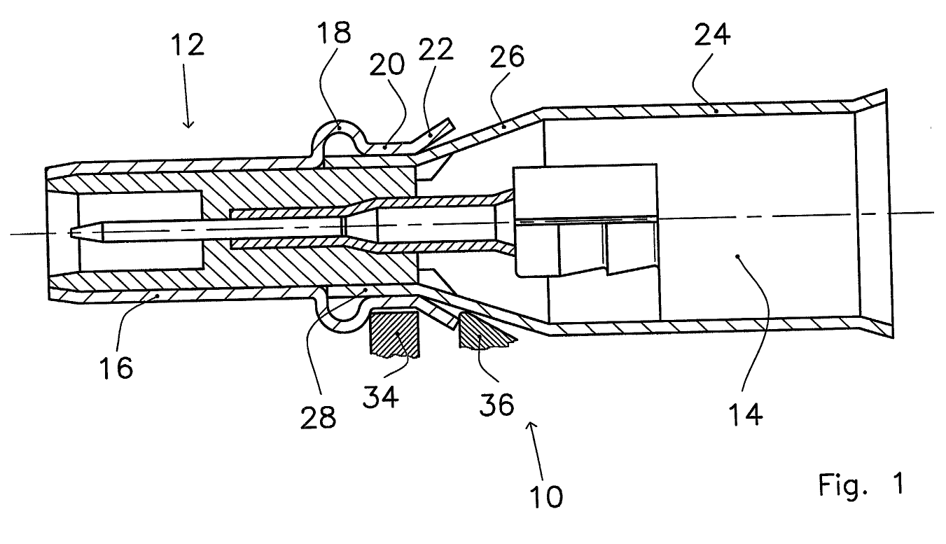

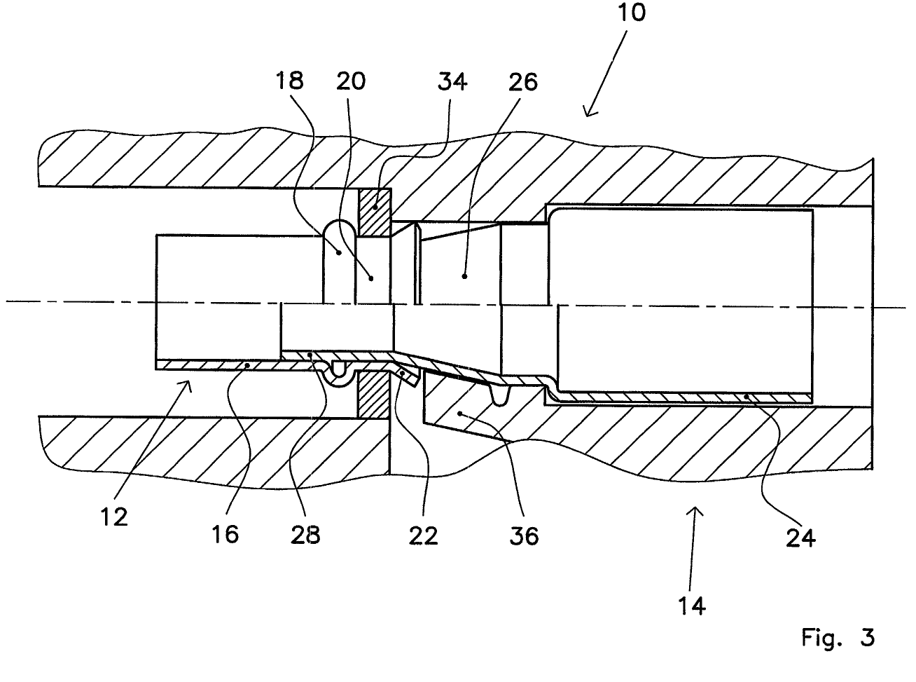

In FIG. 1 there is shown an antenna plug connector which can be plugged into a complementary plug socket. The housing of this plug socket is shown in FIG. 3. The inner structure of plug connector and plug socket is not of importance for the present application; the invention only relates to the design of the housing.

The plug connector shown in FIG. 1 comprises a housing 10 which is made up of a first housing part 12 and a second housing part 14. The first housing part 12 represents the plug side of the plug connector and the second housing part 14 represents the cable side.

The first housing part 12 comprises a cylindrical sleeve 16 which has a slight constriction at the plug-in end. On the other side, the sleeve 16 is adjoined by a radially protruding, surrounding ring 18 which, as seen in cross-section, runs approximately in the shape of a semicircle. Adjoining the ring 18 is a holding section 20 which, in turn, is adjoined by a conically expanded portion 22. The inner diameter of the holding section 20 is slightly larger than the inner diameter of the sleeve 16.

The second housing part 14 likewise has a cylindrical sleeve 24 which at its cable-side end is provided with an expanded portion. Towards the first housing part 12 there is provided an adjoining conical transition section 26 adjacent to which is a cylindrical plug-in collar 28.

The first and second housing parts are produced by plastically deforming a tube section which is cylindrical in the original state. The conical portions of the housing parts and also the ring 18 can be produced, in particular, by a suitable upsetting process.

For joining the first and second housing parts 12, 14, the plug-in collar 28 of the second housing part 14 is pushed into the interior of the holding section 20 of the first housing part 12, until the front side of the second housing part rests against the base of ring 18. As the plug-in collar 28 has the same diameter as the sleeve 16 and the inner diameter of the holding section 20 is larger, by twice the wall thickness of the second housing part 14, than the inner diameter of the sleeve 16, there is produced inside a smooth transition from the plug-in collar 28 to the sleeve 16. By appropriately dimensioning the inner diameter of the holding section 20 of the first housing part, there can be achieved such a press-fit between the first and second housing parts 12, 14, that these two parts, with respect to the forces occurring on handling them, are undetachably connected to each other. Here, the conically expanded portion 22 of the first housing part makes it possible to push the plug-in collar 28 into the first housing part without any problem. This is preferably done in an automated manner.

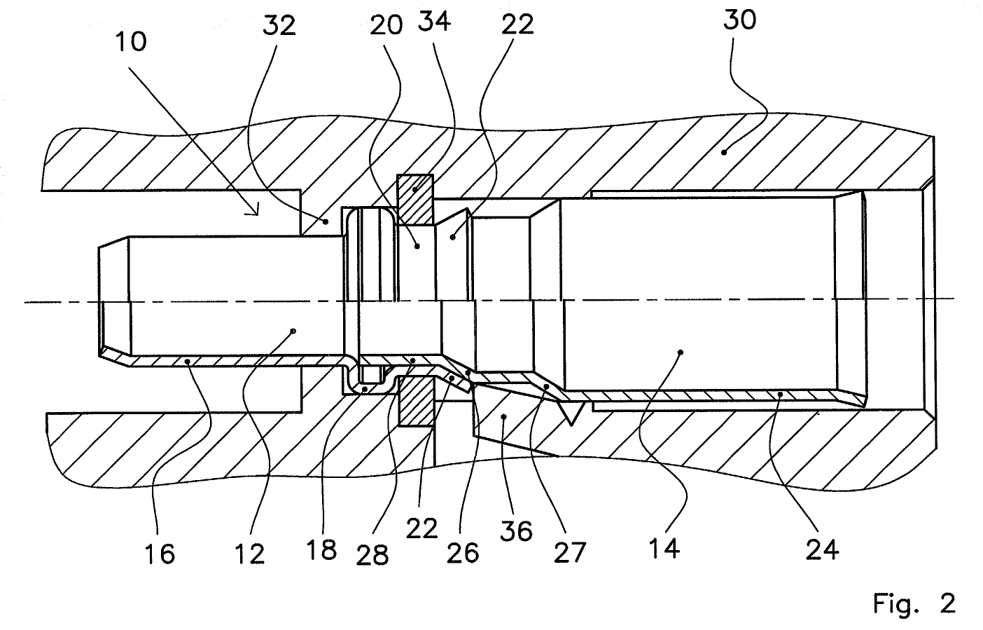

In FIG. 2 there is shown a variant of the housing shown in FIG. 1. Unlike to the design shown in FIG. 1, in the housing of FIG. 2 the transition section 26 of the second housing part 14 is formed to be so short and steep that it snugly fits to the conically expanded portion 22 of the first housing part 12 without any gap. In addition, a further transition section 27 is formed. The result with this variant is an improved stability between the first and second housing part, since the transition section 26 may be supported by the conically expanded portion 22.

In FIG. 2 there is to be seen in which way the formations of the housing cooperate with a receptacle 30 for the housing. The receptacle 30 has a shoulder 32 against which ring 18 rests. On the holding section 20 between the ring 18 and the conically expanded section 22, there engages a slider 34 which is embodied in the nature of a blocking bar and has an oval passage opening. The slider 34 engages the ring 18 on the side facing away from the shoulder 32, so that the housing 10 is firmly arrested in the receptacle. The receptacle is additionally provided with a latching tab 36 which after insertion of the housing into the receptacle latches in place behind the conically expanded portion 22. The latching tab 36 serves to provisionally secure the housing in the receptacle, before the slider 34 engages the holding section 20.

In FIG. 3 there is shown a housing 10 for a plug socket. This housing is likewise made up of first and second housing parts 12, 14 which are inserted into each other. Unlike the first embodiment, the holding section 20 and the sleeve 16 of the first housing part have the same inner diameter, so that in the interior of the sleeve 16 a shoulder is present which is formed by the pushed-in plug-in collar 28. The maximum insertion depth of the second housing part 14 into the first housing part 12 is determined by the abutting of the front end of the conical portion 26 at the conically expanded portion.

1. A housing for a plug connector, in particular for an antenna plug connector, comprising a first housing part and a second housing part which each are made of a plastically deformed tube section and are inserted into each other.

2. The housing according to claim 1, wherein each of said housing parts is made of metal.

3. The housing according to claim 1, wherein said first housing part is provided with a conically expanded portion.

4. The housing according to claim 1, wherein said first housing part, into which said second housing part is inserted, is provided with an upset portion such that a wall of said housing part forms a radially protruding, surrounding ring.

5. The housing according to claim 4, wherein a holding section is formed between said ring and said conically expanded portion.

6. The housing according to claim 5, wherein an inner diameter of said first housing part in a region of said holding section is larger, by twice the wall thickness of said inserted housing part, than in a remaining section and wherein said inserted housing part rests at said base of said ring.

7. The housing according to claim 1, wherein a press-fit is provided between said two housing parts.
